(19) United States
(12) Patent Application Publication
(10) Pub. No.: US 2012/0041998 A1
(43) Pub. Date: Feb. 16, 2012

(54) Network Interface for Accelerating XML Processing

(75) Inventor: Eric T. Lemoine, San Marcos, CA (US)

(73) Assignee: LSI Corporation

(21) Appl. No.: 12/855,806

(22) Filed: Aug. 13, 2010

(51) Int. Cl. G06F 15/16; G06F 15/167

(52) U.S. Cl. 709/201; 709/231; 709/212

(57) ABSTRACT

Described embodiments provide a method of processing data packets received at a network interface of a host device. The network interface detects whether a received data packet is an XML packet. If the data packet is an XML packet, the network interface provides the XML packet to an XML accelerator that performs one or more acceleration operations on the XML packet. The XML accelerator provides processed XML data to a buffer memory and provides an indication to a processor of the host device, the indication including a location of the processed XML data in the buffer. The steps of providing the XML packet to the XML accelerator and performing one or more acceleration operations are performed before an XML data stream corresponding to the XML packet is TCP/IP terminated. If the received data packet is not an XML packet, the network interface provides the data packet to a TCP/IP stack.

### CROSS-REFERENCE TO RELATED APPLICATIONS

The subject matter of this application is related to U.S. patent application Ser. Nos. 12/430,438, filed Apr. 27, 2009, 12/729,226, filed Mar. 22, 2010, 12/729,231, filed Mar. 22, 2010, 12/782,379, filed May 18, 2010, 12/782,393 filed May 18, 2010, and 12/782,411, filed May 18, 2010, the teachings of which are incorporated herein in their entireties by reference.

### BACKGROUND OF THE INVENTION

1. Field of the Invention

The present invention relates to data processing in a communication system, in particular, to acceleration functions of a network processor or network interface card.

2. Description of the Related Art

eXtensible Markup Language (XML), developed by the World Wide Web Consortium (W3C), provides a class of data objects (i.e., XML documents) for conveying data across a distributed computing environment such as the Internet. XML provides a defined format supported on various computer platforms and architectures. An XML document consists of a series of characters, some of which form character data and some of which form markup data. Markup data encodes a description of the document's layout and structure, and includes comments, tags or delimiters (e.g., start tags, end tags, white space), declarations (e.g., document type declarations, XML declarations, text declarations), processing instructions and so on. Character data comprises all document text that is not markup.

Since an XML document is textual in nature, a device that uses the XML document's data must examine the XML document, access its structure and content (e.g., separate character data from markup data) and place the data into a form usable by the device. A large proportion of the processing of an XML document is for decoding and validating the document's characters, tokenizing its content, and creating and maintaining a symbol table for the tokenization. Additional processing is required if a security scheme must be applied to the XML documents, for example, employing a cryptographic key to decrypt or encrypt the document, etc.

XML accelerators have been implemented to process XML documents to reduce the workload of a processor of the device using the XML document. For example, FIG. 1 shows a block diagram of host device 100 that is coupled to network 102, for example the Internet. Host device 100 receives one or more data packets from other devices (not shown) via network 102. The data packets are received by network interface card (NIC) 104, which provides physical access to network 102 and provides low-level processing of data packets, for example, parsing packet headers. TCP/IP stack 106 provides for an implementation of the TCP/IP protocol suite, which, for example, provides i) an interface to the hardware of NIC 104 (network interface layer), ii) device addressing, datagram communication and routing (internet layer), iii) connection management between host device 100 and other devices on network 102 (transport layer), and iv) communicating data to applications and services of processor 108 (application layer). TCP/IP stack 106 also provides TCP/IP termination, for example, to close a connection between host device 100 and another device on network 102 when all the data packets of a stream of data packets comprising a data file have been received. Processor 108 receives data packets from TCP/IP stack 106 and stores the data packets in buffer memory 112. Processor 108 also performs processing on the data packets, for example, reconstructing a stream of received data packets into the corresponding data file.

Upon reconstructing a stream of received data packets, processor 108 might determine that the reconstructed data file is an XML document. Processor 108 might then request that XML accelerator 110 perform accelerated processing of the XML document, for example, by transferring the XML document from buffer memory 112 to XML accelerator 110. However, although the system shown in FIG. 1 provides acceleration of XML processing by offloading at least some XML operations from processor 108 to XML accelerator 110, the system in FIG. 1 incurs overhead and latency costs by having processor 108 manage XML accelerator 110. For example, processor 108 does not send an XML document to XML accelerator 110 until the entire XML file is received and an application running on processor 108 requires access to the XML data. Further, processor 108 must organize and provide the XML data to XML accelerator 110 in certain data structures, which requires processor 108 to access the XML data in buffer memory 112, perform some processing on the XML data, write the data structures to buffer memory 112, and signal XML accelerator 110 to access the data structures from buffer memory 112. Then, XML accelerator 110 might perform its processing of the XML data, and write the resulting data to buffer memory 112 for access by processor 108. Additionally, the overhead and latency costs are proportional to the size of the XML document being processed.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Described embodiments provide a method of processing data packets received at a network interface of a host device. The network interface detects whether a received data packet is an XML packet. If the data packet is an XML packet, the network interface provides the XML packet to an XML accelerator that performs one or more acceleration operations on the XML packet. The XML accelerator provides processed XML data to a buffer memory and provides an indication to a processor of the host device, the indication including a location of the processed XML data in the buffer. The steps of providing the XML packet to the XML accelerator and performing one or more acceleration operations are performed before an XML data stream corresponding to the XML packet is TCP/IP terminated. If the received data packet is not an XML packet, the network interface provides the data packet to a TCP/IP stack.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a prior art host device with an XML accelerator;

FIG. 2 shows a block diagram of a host device with an XML accelerator, in accordance with exemplary embodiments of the present invention;

FIG. 3 shows a block diagram of a network processor with an XML accelerator, in accordance with exemplary embodiments of the present invention; and

FIG. 4 shows a flow diagram of an XML acceleration process, in accordance with exemplary embodiments of the present invention.

### DETAILED DESCRIPTION

In accordance with embodiments of the present invention, an XML accelerator is described for providing pre-processed XML data to a processor as soon as the processor requires the XML data. As described herein, an XML accelerator processes received data packets of an XML file as the data packets are received, and provides the resulting accelerated data structures, via DMA, to a buffer memory that is accessible by the host processor. A software application running on the host processor might request the accelerated data structures from the buffer, and the processor retrieves the accelerated data from the buffer memory. By performing XML acceleration operations independently of the processor, and as the XML data packets are received, system latency for processing XML data is reduced or eliminated.

Table 1 defines a list of acronyms employed throughout this specification as an aid to understanding the described embodiments of the present invention:

TABLE 1

| | | | |
|---|---|---|---|
| USB | Universal Serial Bus | TCP | Transmission Control |
| | | | Protocol |
| SATA | Serial Advanced | IP | Internet Protocol |
| | Technology Attachment | | |
| SCSI | Small Computer System | DDR | Double Data Rate |
| | Interface | | |
| SAS | Serial Attached SCSI | DRAM | Dynamic Random |
| | | | Access Memory |
| PCI-E | Peripheral Component | DMA | Direct Memory Access |
| | Interconnect Express | | |
| SoC | System-on-Chip | API | Application Programming |
| | | | Interfaces |
| XML | eXtensible Markup | NIC | Network Interface Card |
| | Language | | |
| RegEx | Regular Expression | SAX | Simple API for XML |
| JAXP | Java API for XML | DOM | Document Object Model |
| | Processing | | |
| DoS | Denial of Service | | |

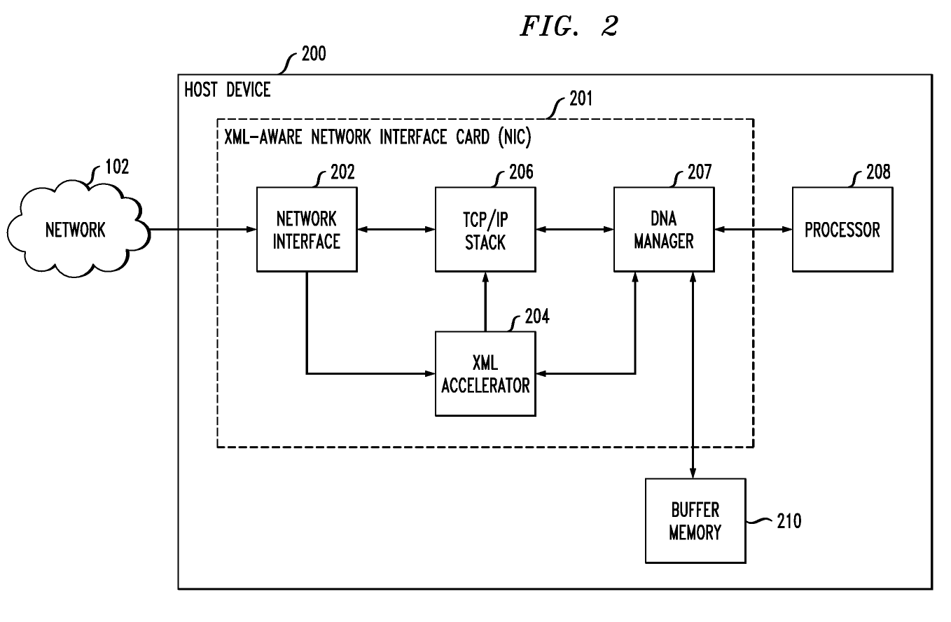

FIG. 2 shows a system for accelerating XML document processing. As shown, host device 200 is in communication with one or more other devices (not shown) via network 102. Host device 200 receives one or more data packets from other devices (not shown) via network 102. The data packets are received by network interface (NI) 202, which provides physical access to network 102 and provides low-level processing of data packets, for example, parsing packet headers. NI 202 is also configured to detect incoming XML documents. XML documents might be detected, for example, by i) detecting an HTTP tag in a header of a received data packet indicating an XML payload, ii) detecting a the sequence “<?xml . . . ” or “<?XML . . . ” in the packet, iii) detecting a known pattern of IP address and requested host port that indicates the packet is an XML packet, and iv) performing a hash operation on the beginning bytes of payload data.

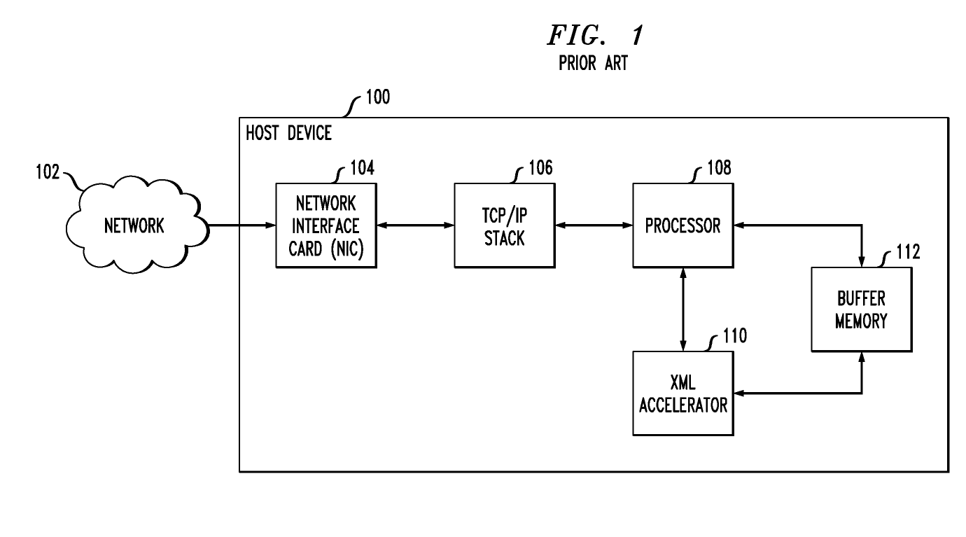

Rather than providing received XML data packets to TCP/IP stack 206, such as described with regard to FIG. 1, NI 202 might provide received XML data packets directly to XML accelerator 204. XML accelerator 204 might include its own TCP/IP stack (not shown) for processing received XML data packets, for example, for performing TCP/IP termination of XML data streams. For example, XML accelerator 204 might detect the end of the XML data streams and TCP/IP terminate the XML data stream automatically, without intervention of processor 208. Alternatively, XML accelerator 204 might “sniff” data packets received by NI 202 while TCP/IP stack 206 performs TCP/IP termination for all received data streams, including XML data streams. In such embodiments of the present invention, XML accelerator 204 might communicate a signal directly to TCP/IP stack 206 to perform the termination of an XML data stream. In embodiments of the present invention, received XML data packets might be copied such that one set of received XML data packets is provided to TCP/IP stack 206, while a second set of received XML data packets is stripped of header data and provided to XML accelerator 204. Together, NI 202, TCP/IP stack 206, DMA Manager 207 and XML accelerator 204 form XML-aware Network Interface Card (NIC) 201. Communication between XML-aware NIC 201 and processor 208 or buffer memory 210 might be by, for example, a PCI-E bus.

XML accelerator 204 receives XML data packets as they arrive at NI 202. XML accelerator might store received XML data packets to buffer memory 210, for example if XML data packets are received out-of-order, or if multiple XML data streams are received concurrently. In some embodiments of the present invention, XML accelerator 204 might begin performing acceleration operations on received XML data packets as they are received, if the packets are in order, rather than waiting for an entire XML document to be received and for the data stream to be TCP/IP terminated. In embodiments of the present invention, XML accelerator 204 might be implemented as an application specific integrated circuit or as a field-programmable gate array.

In embodiments of the present invention, XML accelerator 204 might generate data structures based on received XML data packets, where the data structures enable increased efficiency of operations of processor 208 that employ the XML data. For example, XML accelerator 204 might operate similarly as described in U.S. Pat. Nos. 7,275,069, 7,512,592, and 7,703,006, which are incorporated by reference herein. Operations performed by XML accelerator 204 might be generic, higher-level operations that depend only on the XML input data, and not on specific operations of processor 208, which might not be known until the XML data is required by processor 208. For example, XML accelerator 204 might typically perform i) a document well-formedness check, providing a yes/no with error code indication, ii) an isomorphic structural analysis to determine whether a document of identical structure (not content) has been received before, iii) end of XML document detection, and iv) XML streaming. XML accelerator 204 might also provide statistics about the composition of the XML document, for example to detect file defects and provide tokenization of the XML document into a parsed version of the XML document. XML accelerator 204 might identify and tag previously known XML elements, attributes and namespaces. As described, the output of XML accelerator 204 might typically be less than half the XML original document.

Thus, XML accelerator 204 might perform acceleration operations on received XML data entirely independently of processor 208, and in advance of when the XML data is required by processor 208. XML accelerator 204 might provide a signal to processor 208 indicating a memory location in buffer memory 210 where pre-accelerated XML data is stored. When processor 208 requires the XML data, processor 208 accesses the pre-accelerated data from buffer memory 210. As shown in FIG. 2, processor 208, XML accelerator 204 and TCP/IP stack 206 might access buffer memory by direct memory access (DMA) manager 207.

Typically, a single XML document will be received across multiple packets. Very large XML documents (e.g., 100 MB) can, either intentionally or inadvertently, clog the network connection and overwhelm host device 200 receiving the XML documents. One such example is a denial of service (DoS) attack. Embodiments of the present invention provide that XML accelerator 204 detects reception of such large XML documents before the entire XML document is received and processed. When XML accelerator 204 detects reception of an XML document that would overwhelm host device 200, XML accelerator 204 instructs processor 208 to drop the stream and terminate the TCP/IP connection. Alternatively, in embodiments of the present invention where XML accelerator 204 includes a TCP/IP stack, XML accelerator 204 might automatically terminate the TCP/IP connection. Thus, embodiments of the present invention prevent, for example, a DoS attack, and save system resources of host device 200.

Further, since the XML acceleration operation might typically be complete by the time processor 208 requires the XML data, the overhead latency might typically be fixed, rather than dependent on the amount of XML data, such as described with regard to FIG. 1. For example, as described with regard to FIG. 1, each byte of XML data might typically take 1,000-10,000 clock cycles to perform acceleration operations, and an additional 1,000 clock cycles to route the XML data between the XML accelerator and the buffer memory. As described with regard to FIG. 2, the typical 1,000-10,000 clock cycles per byte to perform acceleration operations might be performed in advance of when processor 208 requires the XML data. Thus, the latency might be reduced from the order of 10,000 clock cycles per byte to the order of 2-50 clock cycles per byte to retrieve pre-accelerated XML data from buffer memory 210.

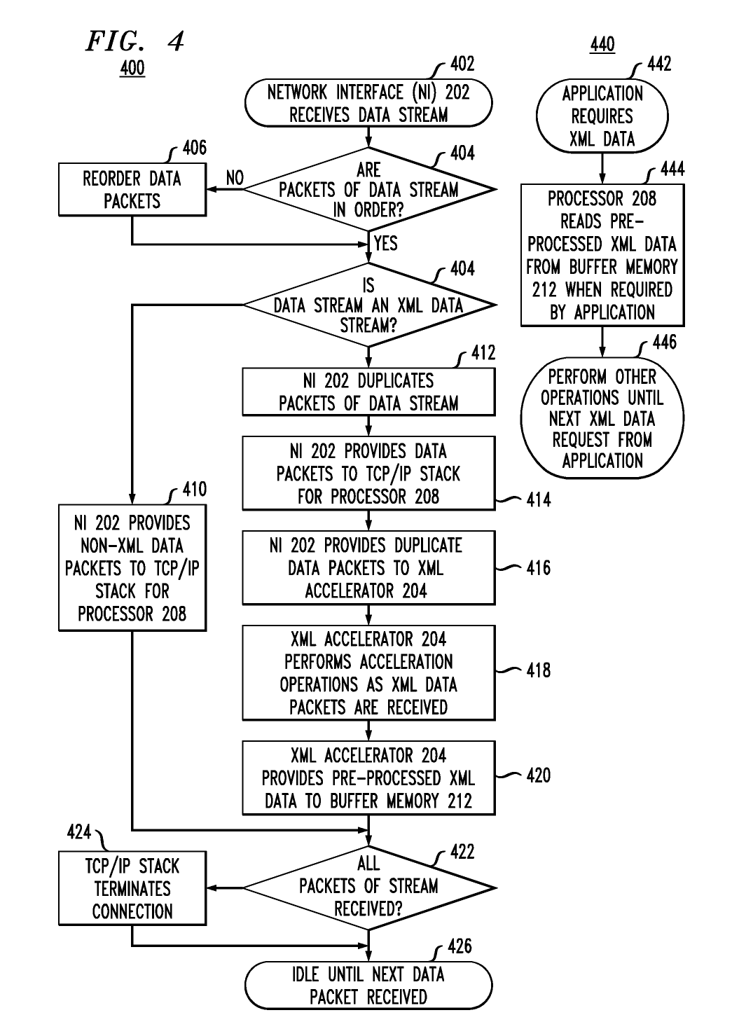

FIG. 4 shows a flow diagram of processes 400 and 440 for processing data packets received by host device 200. Process 400 is performed as host device 200 receives each data packet from network 102. As shown, process 400 is performed generally by network interface (NI) 202 and XML accelerator 204. At step 402, NI 202 receives a data packet from network 102. As described herein, NI 202 performs some processing of the packet, for example, parsing the packet header to determine whether packets of the data stream are received in order. At step 404, if the packets are not received in order, at step 406 the received packets are reordered into the correct order. If the received packets are in the correct order, at step 406 NI 202 determines whether the received data stream is an XML data stream. At step 404, if the received data stream is not an XML data stream, at step 410, NI 202 provides the data stream to TCP/IP stack 206 for processor 208 to perform additional processing corresponding to the data stream. At step 422, if all the packets of the data stream are received, at step 424 TCP/IP stack 206 might terminate the connection. Otherwise, if all packets of the data stream are not received, at step 426, NI 202 and XML accelerator 204 are idle until a next data packet is received from network 102.

At step 404, if the received data stream is an XML data stream, at step 412, NI 202 creates a copy of the packets of the data stream. At step 414, NI 202 provides the data packets to TCP/IP stack 206. At step 416, NI 202 provides the copy of the data packets to XML accelerator 204. At step 418, XML accelerator 204 performs one or more acceleration operations on the XML data. As described herein, XML accelerator 204 might begin acceleration operations prior to receiving all the data packets of the XML data stream and the XML data stream being TCP/IP terminated. At step 420, XML accelerator 204 provides accelerated output data to buffer memory 212. As described herein, the accelerated XML data is generally provided to buffer memory 212 prior to processor 208 requesting the XML data. At step 422, if all the packets of the data stream are received, at step 424 TCP/IP stack 206 might terminate the connection. Otherwise, if all packets of the data stream are not received, at step 426, NI 202 and XML accelerator 204 are idle until a next data packet is received from network 102.

As shown in FIG. 4, process 440 is performed by processor 208 at some time after process 400 has been performed for a given XML data stream. At step 442, an application running on processor 208 might require XML data. At step 444, processor 208 reads the requested XML data from buffer memory 212. The requested XML data is available in buffer memory 212 at the time of the request since XML accelerator 204 performed the acceleration operations as the data packets were received by host device 200. At step 446, processor 208 performs other operations until the next request for XML data. Thus, as shown in FIG. 4, process 400 might generally be performed as each data packet is received by host device 200. XML accelerator 204 might perform acceleration operations on data packets of a received XML data stream as the data packets are received, and before the data stream is TCP/IP terminated. Asynchronously, at some time after the data stream is TCP/IP terminated, process 440 might be performed by processor 208 to retrieve the pre-accelerated XML data from buffer memory 212.

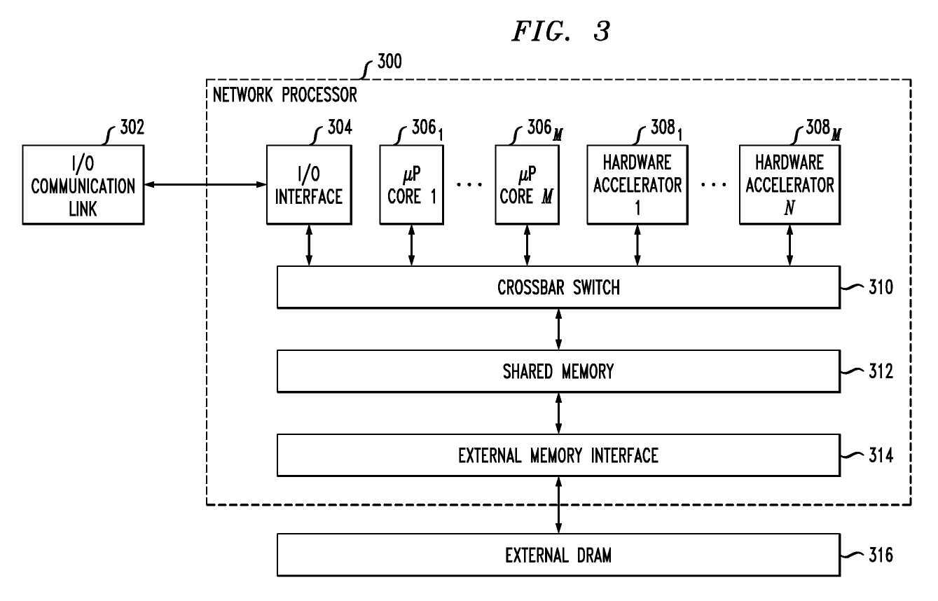

FIG. 3 shows a block diagram of an exemplary network processor 300 employing the XML accelerator described with regard to FIG. 2. As shown in FIG. 3, an exemplary single-chip network processor system might be implemented as a system-on-chip (SoC). Network processor 300 might be used for processing data packets, performing protocol conversion or the like. Embodiments of network processor 300 might typically be used in routers, network cards, and other network devices. As shown, network processor 300 includes on-chip shared memory 312, one or more input-output (I/O) interfaces shown as I/O interface 304, one or more microprocessor (μP) cores shown as μP cores 306₁-3064_{M}, and one or more hardware accelerators 308₁-308_{N}, where M and N are integers greater than 1. Network processor 300 also includes external memory interface 314 for communication with external memory 316. External memory 316 might typically be implemented as a dynamic random-access memory (DRAM), such as a double-data-rate three (DDR-3) DRAM, for off-chip storage of data. In some embodiments, each of the one or more I/O, μP cores and hardware accelerators might be coupled to a switch system, such as crossbar switch 310, which is then coupled to shared memory 312.

I/O interface 304 might typically be implemented as hardware that connects network processor 300 to one or more external devices through I/O Communication link 302. I/O Communication link 302 might generally be employed for communication with one or more external devices, such as a computer system or networking device, that interface with network processor 300. I/O Communication link 302 might be a custom-designed communication link, or might conform to a standard communication protocol such as, for example, a Serial Attached SCSI (“SAS”) protocol bus, a Serial Advanced Technology Attachment (“SATA”) protocol bus, a Universal Serial Bus (“USB”), an Ethernet link, an IEEE 802.11 link, an IEEE 802.15 link, an IEEE 802.16 link, a Peripheral Component Interconnect Express (“PCI-E”) link, a Serial Rapid I/O (“SRIO”) link, or any other interface link. Network processor 300 might operate substantially as described in the above-identified related U.S. patent application Ser. Nos. 12/430,438, filed Apr. 27, 2009, 12/729,226, filed Mar. 22, 2010, 12/729,231, filed Mar. 22, 2010, 12/782,379, filed May 18, 2010, 12/782,393 filed May 18, 2010, and 12/782,311, filed May 18, 2010.

As shown in FIG. 3, XML accelerator 204 might be implemented as one of hardware accelerators 308₁-308_{N}. One or more incoming data packets might be received by I/O interface 304. If an incoming data packet is detected to be an XML data packet, the XML data packet might be stored to shared memory 312 such that the XML accelerator could begin processing the XML document, such as described with regard to FIG. 2.

Typical multi-core SoCs might have one or more concurrent processing threads corresponding to one or more TCP/IP streams received in parallel. Employing an XML processor such as described in regard to FIG. 1 would require that each thread fully receive the entire XML document before XML acceleration is performed. Typically, the XML accelerator might then receive entire XML documents as burst traffic beyond the bandwidth of the network link. For example, to reduce the latency of XML acceleration, the speed of the XML accelerator is often 2-10 times the network bandwidth. As the network data rate increases, XML accelerator speed can become impractical.

Employing an XML accelerator such as described in regard to FIG. 2, the speed of the XML accelerator can be reduced, for example to the speed of the network link (i.e., the XML accelerator can have a data rate of 10 Gbps in a system coupled to a 10 Gbps network). Thus, by providing XML accelerators running at reduced speeds while also reducing the latency of accessing accelerated XML data, embodiments of the present invention provide improved power consumption performance for the SoC, while also providing improved data throughput performance.

Thus, as described herein, embodiments of the present invention provide an XML accelerator for providing pre-processed XML data to a processor as soon as the processor requires the XML data. As described herein, an XML accelerator processes received data packets of an XML file as the data packets are received, and provides the resulting accelerated data structures, via DMA, to a buffer memory that is accessible by the host processor. A software application running on the host processor might request the accelerated data structures from the buffer, and the processor retrieves the accelerated data from the buffer memory. By performing XML acceleration operations independently of the processor, and as the XML data packets are received, system latency for processing XML data is reduced or eliminated. This might allow XML acceleration for standard XML API's such as SAX, DOM or JAXP, which typically require high overhead from the host processor that would offset any gains from performing XML acceleration, such as described with regard to FIG. 1.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processing blocks in a software program, including possible implementation as a digital signal processor, micro-controller, or general purpose computer, the present invention is not so limited. As would be apparent to one skilled in the art, various functions of software may also be implemented as processes of circuits. Such circuits may be employed in, for example, a single integrated circuit, a multi-chip module, a single card, or a multi-card circuit pack.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, whether stored in a non-transitory machine-readable storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of processing data packets, the method comprising:
detecting, by a network interface of a host device, whether a received data packet is an XML packet;
if the data packet is an XML packet:
providing, by the network interface, the XML packet to an XML accelerator;
performing, by the XML accelerator, one or more acceleration operations on the XML packet;
providing, by the XML accelerator, processed XML data to a buffer memory;
providing, by the XML accelerator, an indication to a processor of the host device, the indication including at least a location of the processed XML data in the buffer memory;
otherwise:
providing the data packet to a TCP/IP stack of the processor.

2. The invention recited in claim 1, wherein the steps of providing the XML packet to the XML accelerator and performing one or more acceleration operations on the XML packet are performed before an XML data stream corresponding to the XML packet is TCP/IP terminated.

3. The invention recited in claim 2, further comprising:
reading, by the processor, the processed XML data from the buffer memory once the XML data stream corresponding to the XML packet is TCP/IP terminated.

4. The invention recited in claim 3, further comprising:
performing, by the XML accelerator, TCP/IP termination of the XML data stream; and
performing, by the TCP/IP stack of the processor, TCP/IP termination of non-XML data streams.

5. The invention recited in claim 3, wherein the detecting step includes sniffing, by the XML accelerator, data packets received by the network interface, the method further comprising:
copying, by the XML accelerator, one or more received XML packets; and
performing, by the TCP/IP stack of the processor, TCP/IP termination of XML data streams and non-XML data streams.

6. The invention recited in claim 1, further comprising:
providing a first copy of the XML packet to the XML accelerator; and
providing a second copy of the XML packet to the TCP/IP stack of the processor.

7. The invention recited in claim 6, further comprising removing header data from the first copy of the XML packet.

8. The invention recited in claim 1, further comprising accessing the buffer memory by direct memory access (DMA).

9. A machine-readable storage medium, having encoded thereon program code, wherein, when the program code is executed by a machine, the machine implements a method of processing data packets, the method comprising:
detecting, by a network interface of a host device, whether a received data packet is an XML packet;
if the data packet is an XML packet:
providing, by the network interface, the XML packet to an XML accelerator;
performing, by the XML accelerator, one or more acceleration operations on the XML packet;
providing, by the XML accelerator, processed XML data to a buffer memory;
providing, by the XML accelerator, an indication to a processor of the host device, the indication including at least a location of the processed XML data in the buffer memory;
otherwise:
providing the data packet to a TCP/IP stack of the processor.

10. The invention recited in claim 9, wherein the steps of providing the XML packet to the XML accelerator and performing one or more acceleration operations on the XML packet are performed before an XML data stream corresponding to the XML packet is TCP/IP terminated.

11. The invention recited in claim 10, further comprising:
reading, by the processor, the processed XML data from the buffer memory once the XML data stream corresponding to the XML packet is TCP/IP terminated.

12. The invention recited in claim 11, further comprising:
performing, by the XML accelerator, TCP/IP termination of the XML data stream; and
performing, by the TCP/IP stack of the processor, TCP/IP termination of non-XML data streams.

13. An apparatus for processing received data packets, the apparatus comprising:
a network interface configured to (i) detect received XML packets and (ii) provide received XML packets to an XML accelerator;
the XML accelerator configured to (i) perform acceleration functions on the received XML packets, (ii) provide processed XML data to a buffer memory, (iii) provide a signal to a processor indicating the location of the processed XML data in the buffer memory;
wherein the processor is configured to retrieve the processed XML data from the indicated location in the buffer memory.

14. The invention recited in claim 13, wherein the XML accelerator is configured to perform one or more acceleration operations on the XML packet before an XML data stream corresponding to the XML packet is TCP/IP terminated.

15. The invention recited in claim 14, wherein the processor is configured to read, once the XML data stream corresponding to the XML packet is TCP/IP terminated, the processed XML data from the buffer memory.

16. The invention recited in claim 15, wherein:
the XML accelerator is configured to perform TCP/IP termination of the XML data stream; and
a TCP/IP stack of the processor is configured to perform TCP/IP termination of non-XML data streams.

17. The invention recited in claim 15, wherein:
the XML accelerator is configured to (i) sniff data packets received by the network interface, and (ii) generate a copy of received XML packets;
the TCP/IP stack of the processor is configured to perform TCP/IP termination of XML data streams and non-XML data streams.

18. The invention recited in claim 17, wherein the XML accelerator is configured to remove header data from the copy of the XML packet.

19. The invention recited in claim 13, wherein the XML accelerator and the processor are configured to access the buffer memory by direct memory access (DMA).

20. The invention recited in claim 13, wherein the network processor is implemented in a monolithic integrated circuit chip.
